(19) United States
(12) Patent Application Publication
(10) Pub. No.: US 2026/0089015 A1
(43) Pub. Date: Mar. 26, 2026

(54) IDENTITY VERIFICATION SYSTEM

(71) Applicant: BlackCloak, Inc., Lake Mary, FL (US)

(72) Inventors: Matthew Covington, Lake Mary, FL (US); Christopher Pierson, Lake Mary, FL (US); Aaron Wise, Lake Mary, FL (US); Ryan Black, Lake Mary, FL (US)

(21) Appl. No.: 18/893,456

(22) Filed: Sep. 23, 2024

(51) Int. Cl. H04L 9/32; H04L 9/40; H04W 12/06

(52) U.S. Cl. CPC H04L 9/3271; H04L 63/1416; H04W 12/06

(57) ABSTRACT

The present disclosure provides for technology that addresses technological challenges arising in the field of identity verification. In particular, the present disclosure provides for out-of-band identity verification workflows that allow a first user to issue a verification challenge to a second user to confirm the identity of the second user. For example, the first user may receive a communication claiming to be from the second user. Rather than attempting to confirm the identity of the second user in-band, the first user initiates an out-of-band verification challenge to the second user.

### TECHNICAL FIELD

The present disclosure relates to identity verification systems. In particular, the present disclosure relates to identity verification between users using out-of-band communication mechanisms.

### BACKGROUND

Advances in computer technology have allowed for creation of deepfakes, which are fake but realistic looking images, audio, and videos made with artificial intelligence (AI). While deepfakes may be used for fun and entertainment, deepfakes may also be used with malicious intentions. For example, cybercriminals may use deepfake technology to create fake audio clips to deceive people for personal gain.

Various cybersecurity tools have been developed to combat malicious use of deepfake technology, but these cybersecurity tools suffer from various deficiencies. For example, AI-based tools have been developed to identify manipulated audio and AI-generated voices. While many of these AI-based tools boast high accuracies, they cannot practically be applied to every conversation via every means. In addition, these AI-based tools must be used in line with the communication between cybercriminals and their intended victims and, therefore, may be bypassed by using a different communication channel that the AI-based tools do not support or are not applied. Furthermore, as these AI-based tools are often trained using training data that includes existing deepfakes, these AI-based tools may lag behind deepfake technology. Thus, AI-based tools alone cannot be relied upon for protection against malicious use of deepfake technology.

### BRIEF DESCRIPTION OF THE DRAWINGS

The drawings, which may use like numerals to reference the same or similar elements, depict various example embodiments of the present disclosure for purposes of illustration and are not to be considered as limiting in scope. Thus, one skilled in the art will readily recognize that additional example embodiments are possible without departing from the principles of the present disclosure.

FIG. 1 is a block diagram illustrating an example system, according to some example embodiments.

FIG. 2 is a flowchart illustrating an example method, according to some example embodiments.

FIG. 3 is a flowchart illustrating an example method, according to some example embodiments.

FIG. 4 is a flowchart illustrating an example method, according to some example embodiments.

FIG. 5 illustrates example interfaces, according to some example embodiments.

FIG. 6 illustrates example interfaces, according to some example embodiments.

FIG. 7 illustrates example interfaces, according to some example embodiments.

FIG. 8 illustrates example interfaces, according to some example embodiments.

FIG. 9 illustrates example interfaces, according to some example embodiments.

FIG. 10 illustrates example interfaces, according to some example embodiments.

FIG. 11 is a block diagram showing a software architecture that may be installed on a machine, according to some example embodiments.

FIG. 12 is a diagrammatic representation of a machine, in the form of a computer system, within which a set of instructions may be executed to cause the machine to perform any one or more of the methodologies discussed herein, according to some example embodiments.

### DETAILED DESCRIPTION

As deepfake technology and other technologies that are used to impersonate people continue to improve, identity verification becomes more technologically challenging. As one example, cybercriminals using deepfake technology can create deepfake audio clips and use these deepfake audio clips to impersonate a person. By impersonating the person, the cybercriminals deceive people to gain access to personal information or get a person to transfer money, as some examples. Furthermore, deep fake technology can be used in conjunction with other fraudulent tactics, such as phishing, to impersonate a person and even deceive people who are familiar with the person. For example, cybercriminals using deepfake technology in conjunction with social engineering tactics may impersonate a CEO of a company and target a specific employee in the company. Even though the employee may be familiar with the CEO, the cybercriminals may nevertheless be able to deceive the employee and, for example, convince the employee to transfer money or other valuable assets (e.g., intellectual property) from the company. As these examples illustrate, identity verification is particularly important when facing sophisticated deepfake technology.

While cybersecurity tools to combat the misuse of these technologies exist, these cybersecurity tools are generally deficient, as explained above, because these cybersecurity tools cannot accurately detect all deepfakes and lag behind deepfake technology. Furthermore, these cybersecurity tools that detect deepfakes cannot be efficiently deployed to protect against all attacks. For example, in the CEO example described above, it would be suboptimal and impractical to use cybersecurity tools to monitor all conversations with all employees of the company in order to detect and protect against an attack using deepfakes. In addition, companies are unable to protect the personal devices, accounts, social media accounts, email, text, etc. for individual employees. Furthermore, even if all conversations with all employees were monitored, a deepfake attack can still go undetected because these tools do not accurately detect all deepfakes. Thus, relying on cybersecurity tools to detect deepfakes, alone, is insufficient to protect against deepfake attacks.

Accordingly, the present disclosure provides for technology that addresses the aforementioned technological challenges as well as other technological challenges arising in the field of identity verification. For example, the present disclosure provides for out-of-band identity verification workflows that allow a first user, who is verified by an identity verification system, to issue a verification challenge to a second user, who is also verified by the identity verification system, to confirm the identity of the second user. In this example, the first user receives a communication (e.g., telephone call, video call, text message, voice memo, voicemail) claiming to be from the second user. Rather than attempting to confirm the identity of the second user in-band (e.g., through the received communication), the first user initiates an out-of-band (e.g., outside the communication) verification challenge to the second user. In this out-of-band verification challenge, the first user uses a first user device to send a verification request to the second user. An identity verification system verifies the first user to confirm that the verification request is from a verified user. In response to the verification request from the first user, a second user device can present a verification challenge to the second user. The verification challenge prompts the second user to, for example, answer a security question, enter a security code (e.g., security phrase, security password, security passcode, security pattern), perform a biometric verification (e.g., fingerprint verification, facial recognition verification, voice recognition verification), confirm through actuation within the application, or perform a security action (e.g., upload a contemporaneous photo of an identification). Upon successful completion of the verification challenge, the second user device confirms the verification request from the first user device. The identity verification system verifies the second user to confirm that the completion of the verification challenge is performed by a verified user. Here, the identity verification system acts as the trusted intermediary between the first user and the second user, validating the proofs of identity provided by both the first user and the second user. In response to the confirmation of the verification request, the first user device presents a notification for the first user that the second user has completed the out-of-band verification challenge, which confirms that the communication is indeed from the second user. As illustrated here, additional layers of security allow verified users to confirm each other's identities in the context of a potentially unmonitored communication.

In addition, the out-of-band identity verification workflows allow a first user to determine that a communication claiming to be from a second user is fraudulent. For example, the first user receives a communication claiming to be from the second user and initiates an out-of-band verification challenge to the second user. The first user uses a first user device to send a verification request to the second user. An identity verification system verifies the first user to confirm that the verification request is from a verified user. In response to the verification request from the first user, a second user device presents a notification to the second user that a verification request was made and presents a verification challenge to the second user. In this example, the second user is not in communication with the first user and declines the verification challenge. The identity verification system verifies the second user to confirm that the declination of the verification challenge is from a verified user. In response to the declination of the verification challenge, the second user device rejects the verification request from the first user device. The first user device presents a notification for the first user that the second user declined the out-of-band verification challenge, which confirms that the communication is not from the second user and is likely fraudulent. This can also allow for the alerting of certain conditions to a centralized response team or other users of the platform. As illustrated here, additional layers of security allow verified users to confirm that a communication is indeed fraudulent.

As these examples illustrate, the present disclosure provides addresses technological challenges resulting from use of deepfake technology by providing identity verification workflows that resist impersonation. For example, cybercriminals with access to sophisticated deepfake technology may be able to create convincing deepfakes that defeat deepfake detection tools. However, these convincing deepfakes are ineffective against the direct identity verification facilitated by the out-of-band verification challenges described in the present disclosure. Thus, the present disclosure provides for technological solutions that address even sophisticated deepfake technologies. Further details related to the various functions and the improvements provided by the present disclosure are described below.

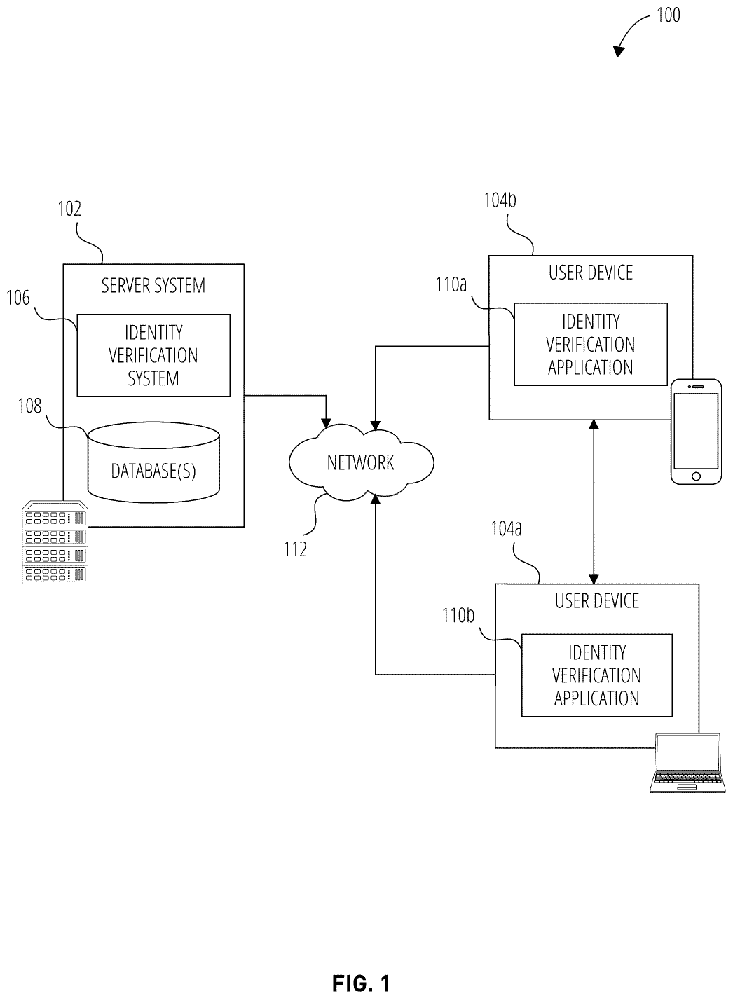

FIG. 1 is a block diagram illustrating an example system 100, according to some example embodiments. The example system 100 includes a server system 102 and one or more user devices, such as a user device 104a and a user device 104b. The elements illustrated in this figure and all figures herein are for illustrative purposes, and other example embodiments may include additional, fewer, or different elements. Some elements may not be shown so as not to obscure relevant details.

In the example system 100, the one or more user devices, such as the user device 104a and the user device 104b, comprise, but are not limited to, mobile phones, desktop computers, laptop computers, portable digital assistants (PDAs), smart phones, tablets, ultra books, netbooks, multi-processor systems, microprocessor-based or programmable consumer electronics, game consoles, set-top boxes, wearable computing devices, or any other communication devices that a user may utilize to access the example system 100. In some examples, the one or more user devices comprise a display module (not shown) or a display device (not shown) to display information (e.g., in the form of user interfaces). In some examples, the one or more user devices comprise one or more of touch screens, accelerometers, gyroscopes, cameras, microphones, global positioning systems (GPS) devices, biometric devices, and so forth.

In the example system 100, the one or more user devices, such as the user device 104a and the user device 104b, communicate with each other and/or with the server system 102 via a network 112. One or more portions of the network 112 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks. In some examples, the one or more user devices communicate with each other without relying on the network 112, such as via Bluetooth, infrared (IR), Wi-Fi Direct, Near Field Communication (NFC), or other modes of communication.

The one or more user devices, such as the user device 104a and the user device 104b, may access various data and software provided via the example system 100 using a web client (e.g., a web browser) or other application. In general, the one or more user devices may include one or more applications (also referred to as “apps”) such as, but not limited to, a web browser, a messaging application, an electronic mail (e-mail) application, a social networking application, an e-commerce site application, a mapping or location application, an identity verification application, such as identity verification application 110a or identity verification application 110b, and the like. In some examples, the one or more applications are included in a user device, and configured to locally provide the user interface and at least some of the application functionalities. The one or more applications may be configured to communicate with other entities in the example system 100 (e.g., user device 104a, user device 104b, server system 102, other devices, other systems), on an as-needed basis, for data and/or processing capabilities not locally available (e.g., sending and receiving electronic communication, accessing electronic communication, sending location data, sending biometric data). In some examples, the one or more applications may not be included in a user device, and the user device may use its web client (e.g., web browser) to access the one or more applications hosted on other entities in the example system 100 (e.g., server system 102).

The one or more applications, such as the identity verification application 110a and the identity verification application 110b, are provided to or maintained in a repository. In some examples, the one or more applications are uploaded or otherwise transmitted over a network, such as the network 112, to the repository. In some examples, the repository includes an “app” store in which the one or more applications are maintained for access or download. For example, in response to a command from a user device to access or download an application, the application is provided or otherwise transmitted over the network from the repository to the user device.

In the example system 100, the server system 102 provides server-side functionality via the network 112 to one or more third-party servers and to one or more user devices, such as the user device 104a and the user device 104b. The server system 102 includes an identity verification system 106 and one or more database(s) 108. The database(s) 108 are storage devices that store information such as user information, unique identifiers for users and user devices, location data, biometric data, image data, historical data, and so forth.

The identity verification system 106 provides identity verification functionality to the server system 102. In some examples, the identity verification system 106 provides login functionality. A user logs in to the identity verification system 106 using login credentials maintained by the identity verification system 106 (e.g., in the database(s) 108), enterprise login credentials (e.g., login credentials provided by an organization), or third-party login credentials (e.g., login credentials associated with a third-party provider). For example, a user creates login credentials through the identity verification system 106. These login credentials are maintained by the identity verification system 106, and the user logs in using these login credentials. As another example, an enterprise, such as a corporate entity that employs the user, provides login credentials that the user uses to log in. The user logs in using these login credentials. As another example, the user identifies a third-party provider, such as an e-mail provider or a social network provider, and the third-party provider provides login credentials that the user uses to log in. The user logs in using these login credentials. In some examples, the user logs in using a single sign on (SSO) workflow, such as a Security Assertion Markup Language (SAML) workflow, an OpenID Connect (OIDC) workflow, or an OAuth 2.0 workflow. In response to a login request from the user, the identity verification system 106 sends a request to an enterprise-hosted identity provider for authentication. The user authenticates with the enterprise via the enterprise-hosted identity provider. The enterprise-hosted identity provider provides a token to the identity verification system 106, and the identity verification system 106 completes the login based on the token.

In some examples, if the login credentials are provided by a third-party provider, the login credentials are required to be associated with an aged account (e.g., an account in existence for a threshold period of time). For example, if a user identifies a third-party provider that provides login credentials for an account that has been recently created with the third-party provider (e.g., within a month, within 6 months, within 1 year), then the login credentials provided by the third-party provider are rejected. In this example, the user is prompted to identify another third-party provider. For example, the user can log in using a SSO workflow through the third-party provider. The identity verification system 106 requests authentication of the user from an identity provider hosted by the third-party provider. The user authenticates with the third-party provider through the third-party identity provider. Upon successful authentication, the third-party identity provider provides a token to the identity verification system 106 that authenticates the user and allows the user to log in.

In some examples, login functionality includes multi-factor authentication. For example, a user that attempts to log in using login credentials may also receive one or more verification codes through e-mail, SMS messages, or phone calls to further verify the login attempt.

In some examples, the identity verification system 106 provides user relationship functionality. For example, the identity verification system 106 maintains information describing contacts who may initiate a verification challenge with a user, such as family members of the user, friends of the user, employees who work at the same corporate entity as the user, and so forth. The information describing the contacts include the relationship with the user (e.g., family relationship, friend relationship, company relationship) and verification history. The verification history includes a log of verification challenges issued between the contact and the user. For each verification challenge issued between the contact and the user, information associated with the verification challenge is maintained. The information associated with the verification challenge includes a timestamp associated with when a verification challenge was requested, whether the verification challenge was successfully completed, whether the verification challenge was failed, whether the verification challenge timed out, whether the verification challenge was denied, a timestamp associated with successful completion, failure, time out, or denial of the verification challenge, a type of verification challenge issued, location information of the contact when the verification challenge was requested, location information of the user when the verification challenge was requested, successfully completed, failed, timed out, or denied, device details associated with a device used by the contact to request the verification challenge, device details associated with a device used by the user to successfully complete, fail, or deny the verification challenge, and so forth. The information maintained through the user relationship functionality serves as evidence that is used to identify incidents of fraud, compromised devices, and other potentially malicious events. For example, based on the verification history, the identity verification system 106 can determine that a contact of a user is repeatedly requesting (e.g., requesting within a threshold period of time) verification challenges for the user and that the verification challenges are requested from different devices with different device details and different location information. This activity is indicative of an authentication fatigue attack and that the contact has a compromised account. Rehabilitative actions, such as closing the compromised account, notifying an account manager, notifying contacts of the compromised account, and so forth, are taken in response to a determination the account is compromised, potentially preventing further attacks.

In some examples, the identity verification system 106 provides user history functionality. For example, the identity verification system 106 maintains information describing a user, actions performed by a user, and devices used by the user. The information describing the user includes, for example, biometric data (e.g., fingerprints, facial images), identification data (e.g., government issued identification, security questions/answers), personal preferences (e.g., travel rules, preferred device for responding to verification challenges), and so forth.

The information describing actions performed by the user includes, for example, a location history, log in history, verification request history, verification challenge history, and so forth. The verification request history includes a log of when verification challenges were requested by a user and from whom the verification challenges were requested. The verification challenge history includes a log of when verification challenges that were successfully completed, verification challenges that were failed, verification challenges that timed out, and verification challenges that were denied. The log of verification challenges includes what types of verification challenges were successfully completed, failed, timed out, and denied.

The information describing devices used by the user includes, for example, IMEI information, cellular network information, MAC address information, identification metadata (e.g., unique identifiers), and so forth. The information maintained through the user history functionality, which in some examples is used in conjunction with the information maintained through the user relationship functionality described above, serves as evidence for identifying incidents of fraud, compromised devices, and other potentially malicious events. For example, the identity verification system 106 can determine, based on device information, location history, and log in history, that login credentials of a user are compromised because a log in from an unrecognized device at a location outside of a threshold distance from a previous location occurred. In response to the determination of the compromised login credentials, rehabilitative actions, such as closing the compromised account, notifying an account manager, notifying contacts of the compromised account, and so forth, are taken in response to a determination the account is compromised, potentially preventing further attacks.

In some examples, the identity verification system 106 identifies potentially fraudulent or malicious events, such as compromised accounts and compromised devices, based on a risk score calculated from information related to a user (e.g., information maintained through user relationship functionality, information maintained through user history functionality). The identity verification system 106 calculates the risk score using, for example, a weighted average or a weighted sum of risk values associated with the information related to the user. For example, a change in location is associated with a risk value indicative of a distance of the change in location. The risk value is weighted in accordance with how likely a change in location correlates with a potentially fraudulent or malicious event. The weighted risk value is averaged or summed with other weighted risk values to determine a risk score. In some examples, a potentially fraudulent or malicious event is determined based on the risk score exceeding a threshold risk score threshold. In some examples, a potentially fraudulent or malicious event is determined based on a delta in risk score exceeding a threshold risk score delta threshold. For example, the identity verification system 106 receives a login attempt from a new device. The use of a new device is associated with a first risk value. In this example, the login attempt uses the wrong credentials, and this login attempt with the wrong credentials is associated with a second risk value. The first risk value is weighted with a first weight associated with the likelihood that a new device correlates with a potentially fraudulent or malicious event. The second risk value is weighted with a second weight associated with the likelihood that a wrong credential correlates with a potentially fraudulent or malicious event. In this example, a risk score is determined using a weighted sum including the first weighted risk value and the second weighted risk value. If the risk score exceeds a risk score threshold, a determination that an account associated with the login attempt is compromised. Rehabilitative actions are taken accordingly.

In some examples, the identity verification system 106 provides alerts in response to a determination of potentially fraudulent or malicious events, such as a compromised device, a compromised account, and so forth. For example, the identity verification system 106 provides notifications via e-mail, SMS, or via push messages delivered through an identity verification application, such as the identity verification application 110a or the identity verification application 110b. In some examples, the identity verification system 106 sets a status associated with a compromised account or a compromised device to indicate that the account or the device has been compromised. The status appears to those seeking to request a verification challenge from the compromised account or the compromised device to indicate that the account or the device is compromised. Similarly, the status appears to those receiving a verification challenge from a compromised account or a compromised device to indicate that the account or the device is compromised. The status appears, for example, as an icon (e.g., alert icon, warning icon).

In some examples, the identity verification system 106 facilitates a verification challenge between users. For example, the identity verification system 106 receives a verification request from a first user using a first device, such as the user device 104a, to verify an identity of a second user. The identity verification system 106 logs the verification request including information associated with the verification request, such as a timestamp of when the verification request was made, user information associated with the first user who made the verification request, device information associated with the first device that sent the verification request, and so forth. In this example, the identity verification system 106 selects a verification challenge for the second user to perform and transmits the verification challenge to a second device, such as the user device 104b, of the second user. The identity verification system 106 receives a response to the verification challenge from the second user using the second device and logs the response including information associated with the response, such as a timestamp of when the response was made, user information associated with the second user when the response was made, device information associated with the second device when the response was made, and so forth. The identity verification system 106 determines whether the response to the verification challenge is correct, incorrect, timed out, or a denial of the verification challenge. A notification indicating, for example, that the response to the verification challenge is correct, the response to the verification challenge is incorrect, the verification challenge timed out, or the verification challenge is denied is transmitted to the first user.

In the example system 100, the identity verification application 110a and the identity verification application 110b provide identity verification functionality to the user device 104a and the user device 104b respectively. For example, a first user using the user device 104a requests a verification challenge from a second user using the identity verification application 110a. In this example, the identity verification application 110a provides a log in interface through which the first user enters login credentials. The identity verification application 110a logs successful and unsuccessful login attempts. The login attempts are provided to the identity verification system 106 along with, for example, time stamps, location information, and device information associated with each login attempt.

Upon a successful log in, the identity verification application 110a provides an address book interface that includes a list of contacts of the first user from whom the first user can request a verification challenge. The address book interface allows the first user to add contacts to the list of contacts. Adding a contact to the list of contacts includes providing contact information (e.g., name, telephone number, account id, account number). In some examples, the identity verification application 110a has access to a device contact list (e.g., phone book) on the user device 104a and adds contacts to the list of contacts based on an identification of contacts in the device contact list that have an account with the identity verification system 106. In this example, the first user selects the second user from the list of contacts. Upon selection of the second user from the list of contacts, the identity verification application 110a transmits a verification request, for example, to the identity verification system 106. In this example, the identity verification application 110a receives a notification from the identity verification system 106 indicating that the verification challenge was successfully completed, failed, timed out, or denied. Based on the notification, the identity verification application 110a displays a message indicating, for example, that the second user was able to successfully complete the verification challenge, was unable to successfully complete the verification challenge, timed out, or denied the verification challenge. The message can include additional instructions based on the results of the verification challenge. For example, the message can include instructions to continue communication with the second user based on the verification challenge being successfully completed. The message can include instructions to immediately cease all communication with whoever is claiming to be the second user based on the verification challenge being failed, timed out, or denied.

In some examples, a type of verification challenge is selected by a user who requests the verification challenge. For example, in response to a selection of a contact from a list of contacts, the identity verification application 110a provides a verification challenge selection interface that includes a list of verification challenges to be issued to the selected contact. The list of verification challenges can include, for example, security question challenges (e.g., answering a security question, entering a security code, entering a security pattern), biometric challenges (e.g., providing a fingerprint verification, providing a facial recognition verification), confirm through actuation within the application, and security action challenges (e.g., uploading a contemporaneous photo). In some examples, the type of verification challenge is based on a security profile, for example, set by an administrator or a chief information security officer. For example, a chief information security officer can indicate in a security profile which verification challenges are sufficiently secure for identity verification. Users covered by the security profile may be limited to the verification challenges indicated in the security profile. In some examples, a type of verification challenge is selected automatically, for example, by the identity verification system 106. For example, the identity verification system 106 can select verification challenges to maintain an even distribution of the types of verification challenges that are provided, to prioritize types of verification challenges that a user fails with greater frequency than other types of verification challenges, and so forth.

In some examples, such as if a connection with the identity verification system 106 is unavailable, the identity verification application 110a causes the verification request to be sent directly (e.g., via Bluetooth, infrared (IR), Wi-Fi Direct, Near Field Communication (NFC)) from a first device, such as user device 104a, to a second device, such as user device 104b. The verification challenge can involve a biometric verification (e.g., fingerprint verification, facial recognition verification, voice recognition verification) or a security action (e.g., upload a contemporaneous photo of an identification, upload a contemporaneous self photo) that is verifiable by a first user of the first device. For example, a first user uses a first device to request a verification challenge from a second user of a second device via a Wi-Fi Direct connection. The verification challenge in this example can be to provide a contemporaneous photo of the second user. As the second device is within a range of the first device that is supported by the Wi-Fi Direct connection, the first user can verify that the contemporaneous photo is from a location within the range, for example, by looking at the background of the contemporaneous photo.

In some examples, the verification challenge involves a challenge and response that uses security information that is stored on the first device. The security information stored on the first device can be, for example, a portion of the security information that is stored on the identity verification system 106. In some examples, the security information stored on the first device is periodically updated when the identity verification system 106 is available. For example, a first user using a first device seeks to request a verification challenge from a second user with a second device. In this example, an identity verification system maintains information, such as correct security responses, for different verification challenges, such as different security questions, that the second user can complete to verify the identity of the second user. The first user device maintains information for one of the verification challenges to use in an environment where access to the identity verification system is unavailable. In this example, the information is one correct security response for one security question. When the identity verification system is unavailable, the first device requests a verification challenge from the second device using the one security question for which the first device can verify using the one correct security response. The first device receives a response from the second device for the verification challenge and determines whether the verification challenge is successfully completed or failed based on the information stored in the first device (e.g., the response matches the one correct security response).

The identity verification functionality provided by the identity verification application 110a and the identity verification application 110b includes responding to verification challenges. For example, a first user using a first device, such as user device 104a, receives a verification challenge in response to a verification request from a second user using a second device, such as user device 104b. In this example, the identity verification application 110a provides a verification challenge interface that includes a verification challenge for the first user to complete. The first user enters a response to the verification challenge via the verification challenge interface. The response is transmitted, for example, to the identity verification system 106 or the user device 104b to determine whether the verification challenge is successfully completed or failed. In some examples, the first user fails to respond to the verification challenge within a threshold period of time (e.g., 1 minute, 5 minutes, 10 minutes). Failure to respond to the verification challenge within the threshold period of time may indicate that the first user may not be expecting a verification challenge because the first user is not attempting to communicate with anyone or that the first user is busy doing something besides attempting to communicate with someone. In some examples, the first user denies the verification challenge as the response to the verification challenge. Denying the verification challenge indicates that the first user is not attempting to communicate with anyone and, therefore, does not expect a verification challenge. In some examples, prior to providing the verification challenge interface, the identity verification application 110a provides a log in interface for the first user to enter login credentials before being provided with an opportunity to respond to the verification challenge. The log in interface may provide an extra layer of security to further verify the identity of the first user.

In some examples, a verification challenge is requested through a lightweight application that does not facilitate responses to verification challenges. For example, a first user may be in a position in a company that regularly issues instructions to other employees in the company, and these instructions need to be verified. In this example, the other employees in the company use the lightweight application that only requests verification challenges. The first user uses an application that requests verification challenges and responds to verification challenges. Having a lightweight application that only facilitates verification requests may be more resource efficient. Furthermore, maintaining accounts for users who use the lightweight application does not require storage of verification challenge responses as these users do not respond to verification challenges.

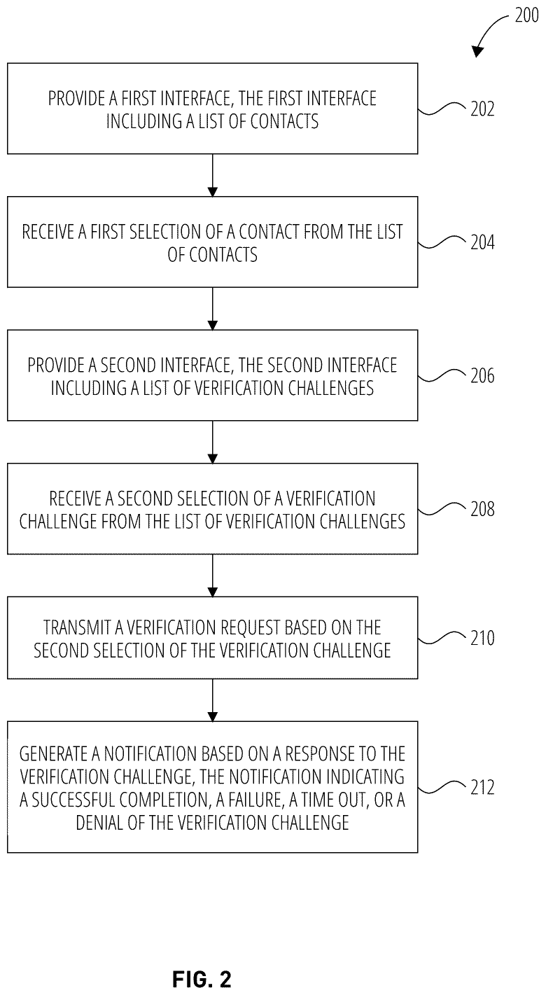

FIG. 2 is a flow chart illustrating an example method 200, according to some example embodiments. The example method 200 illustrates example operations performed by a computing device, such as the user device 104a or the user device 104b, to request a verification challenge. While the example methods of the present disclosure may depict particular sequences of operations, the sequences may be altered without departing from the scope of the present disclosure. For example, some of the operations depicted may be performed in parallel or in a different sequence that does not materially affect the functions of the example methods. In some examples, different components of an example device or an example system that implements any one of the example methods may perform functions at substantially the same time or in a specific sequence.

In some examples, the example method 200 starts in response to a first user receiving a communication that claims to be from a second user. To verify the identity of the second user, the first user seeks to request an out-of-band verification challenge to the second user. In some examples, a computing device of the first user detects that communication is associated with a malicious or fraudulent event and generates a notification for the first user accordingly. For example, the computing device detects keywords (e.g., audible keywords in a call or video) associated with malicious or fraudulent events. The keywords include, for example, “payment,” “social security number,” “routing number,” “account number,” “password,” “username,” and the like. The first user interacts with the notification to open an identity verification application and initiate the out-of-band verification challenge. This initiates the example method 200. At operation 202, the computing device provides a first interface that includes a list of contacts. For example, as described above with respect to FIG. 1, the user device 104a, using the identity verification application 110a, provides an address book interface that includes a list of contacts for a first user. The list of contacts includes contacts to whom the first user can send a request for a verification challenge.

At operation 204, the computing device receives a selection of a contact from the list of contacts. For example, the first user selects the second user, the user from whom the communication claims to be and who is using the user device 104b, from the list of contacts.

At operation 206, the computing device provides a second interface, the second interface including a list of verification challenges. For example, as described above with respect to FIG. 1, the user device 104a, using the identity verification applications 110a, provides a verification challenge selection interface that includes a list of verification challenges to be issued to the second user. Verification challenges include security question challenges (e.g., answering a security question, entering a security code, entering a security pattern), biometric challenges (e.g., providing a fingerprint verification, providing a facial recognition verification), confirm through actuation within the application, and security action challenges (e.g., uploading a contemporaneous photo). In some examples, the list of verification challenges is based on a security profile that indicates which verification challenges can be issued. For example, the security profile can indicate that verification challenges for the second user are limited to security action challenges. In some examples, the second interface allows the first user to specify a communication method (e.g., SMS, voice mail, video call, social media post, e-mail, telephone call) to be verified through a verification challenge. For example, the second interface includes a list of communication methods from which the first user selects. The second user confirms the communication method as part of the verification challenge.

At operation 208, the user device receives a selection of a verification challenge from the list of verification challenges. For example, the first user selects, via the verification challenge selection interface, a first verification challenge to be issued to the second user. In some examples, a verification challenge is selected automatically. As described above with respect to FIG. 1, the verification challenge can be selected automatically by an identity verification system to maintain an even distribution of verification challenges issued, to prioritize verification challenges that a user fails with greater frequency than other verification challenges, and so forth. The automatically selected verification challenge can be provided as a recommended verification challenge that the first user selects.

At operation 210, the user device transmits a verification request based on the first verification challenge. For example, the user device 104a sends a verification request to the user device 104b, directly or through the identity verification system 106.

At operation 212, the user device generates a notification based on a response to the verification challenge. The notification indicates a successful completion, a failure, a time out, or a denial of the verification challenge. As described above with respect to FIG. 1, a successful completion of the verification challenge indicates that a user provided a correct response to the verification challenge. A failure of the verification challenge indicates that the user provided an incorrect response to the verification challenge. A time out of the verification challenge indicates that the user failed to respond to the verification challenge within a threshold period of time. A denial of the verification challenge indicates that the user refused to respond to the verification challenge, which indicates that the user is not attempting to communicate with anyone and is not expecting a verification challenge. For example, the user device 104a determines, based on a notification from the identity verification system 106 or based on a response received directly from the user device 104b, whether the second user successfully completed, failed, timed out, or denied the verification challenge. The user device 104a, using the identity verification application 110a, generates a notification for the first user accordingly.

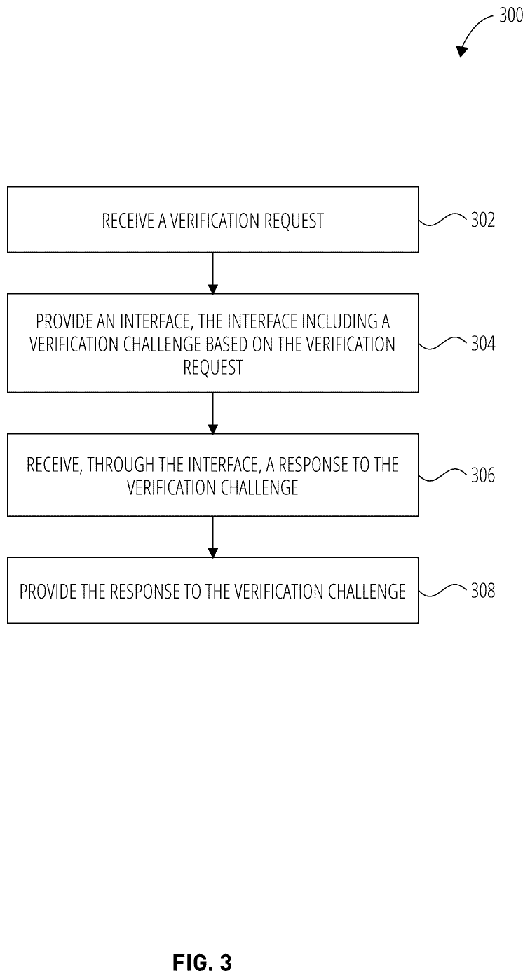

FIG. 3 is a flow chart illustrating an example method 300, according to some example embodiments. The example method 300 illustrates example operations performed by a computing device, such as the user device 104a or the user device 104b, to respond to a verification request.

At operation 302, the computing device receives a verification request. For example, a first user using the user device 104a sends a verification request, using identity verification application 110a, to confirm the identity of a second user using the user device 104b, as explained above. In this example, the second user receives the verification request on user device 104b using identity verification application 110b. The verification request is received, for example, in response to the first user seeking to confirm that a communication that claims to be from the second user is indeed from the second user.

At operation 304, the computing device provides an interface including a verification challenge based on the verification request. For example, in response to receiving the verification request from the user device 104a, the user device 104b provides a verification challenge interface using the identity verification application 110b. The verification challenge interface includes a verification challenge, such as a security question, to which the second user can respond.

At operation 306, the computing device receives, through the interface, a response to the verification challenge. For example, the second user may receive a verification challenge to respond to a security question on the verification challenge interface. The second user uses the verification challenge interface to enter a response to the security question.

At operation 308, the computing device provides the response to the verification challenge to the identity verification system 106 or user device 104a. For example, the user device 104b, using the identity verification application 110b sends the response entered by the second user, for example, to the identity verification system 106 or to the user device 104a to verify the response. The identity verification system 106 or the user device 104a verifies the identity of the second user based on the response. For example, if the response is a correct response to the verification challenge, then the identity of the second user is verified. This allows the first user to confirm that the communication from the second user is actually from the second user. If the response is an incorrect response to the verification challenge, then the identity of the second user is unverified. If the second user chooses to deny the verification challenge, then the identity of the second user is unverified. If the identity of the second user is unverified, then the first user understands that the communication claiming to be from the second user is fraudulent.

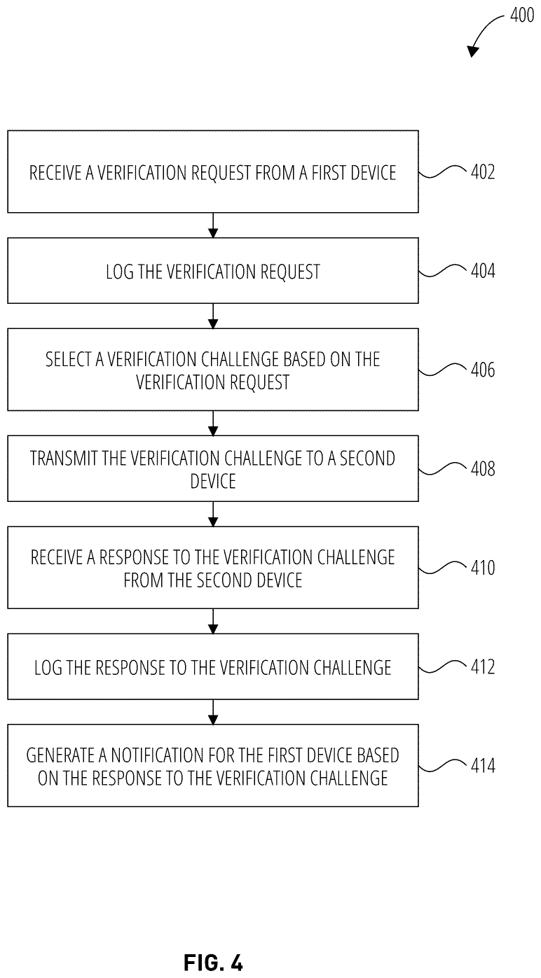

FIG. 4 is a block diagram illustrating an example method 400, according to some example embodiments. The example method 400 illustrates example operations performed by a system, such as the server system 102, for facilitating verification challenges.

At operation 402, the computing system receives a verification request from a first device. For example, the server system 102 receives a verification request from a first user using the user device 104a to verify an identity of a second user using the user device 104b.

At operation 404, the computing system logs the verification request. For example, the server system 102, using the identity verification system 106, logs information, such as time stamps, location, and device details, related to the verification request received from the user device 104a.

At operation 406, the computing system selects a verification challenge based on the verification request. For example, the server system 102, using the identity verification system 106, selects a verification challenge from a list of verification challenges for the second user. For example, the identity verification system 106 can select verification challenges to maintain an even distribution of the verification challenges that are provided or to prioritize verification challenges that a user fails with greater frequency than other verification challenges.

At operation 408, the computing system transmits the verification challenge to a second device. For example, the server system 102 transmits the verification challenge that was selected from the list of verification challenges to the second user via the user device 104b.

At operation 410, the computing system receives a response to the verification challenge from the second device. For example, the second user provides a response to the verification challenge sent to the user device 104b. The response is sent to and received by the server system 102.

At operation 412, the computing system logs the response to the verification challenge. For example, the server system 102, via the identity verification system 106, logs information, such as time stamps, location, and device details, related to the response to the verification challenge. The server system 102, via the identity verification system 106, determines whether the response to the verification challenge is correct. For example, if the response is a correct response to the verification challenge, then the identity of the second user is verified. The server system 102 sends a notification to the user device 104a indicating that the second user is verified, which allows the first user to confirm a communication with the second user. If the response is an incorrect response to the verification challenge, then the identity of the second user is unverified. The server system 102 sends a notification to the user device 104a indicating that the second user is unverified, which indicates to the first user that a communication that claims to be from the second user is likely fraudulent. If the second user does not respond to the verification challenge within a threshold period of time, then the identity of the second user is unverified. The server system 102 sends a notification to the user device 104a indicating that the second user timed out the verification challenge, which indicates to the first user that a communication that claims to be from the second user is likely fraudulent. If the second user chooses to deny the verification challenge, then the identity of the second user is unverified. The server system 102 sends a notification to the user device 104a indicating that the second user denied the verification challenge, which indicates to the first user that a communication that claims to be from the second user is likely fraudulent.

The server system 102, using the identity verification system 106, can also determine whether the information related to the response to the verification challenge is indicative of a malicious or fraudulent event. For example, the information related to the response includes, for example, timestamp information related to the response, location information related to the device used for the response, and device information of the device used for the response. In some examples, timestamp information can indicate that the response was provided outside a threshold period of time from when the verification challenge was provided. Providing a response to a verification challenge outside the threshold period of time can indicate that a potentially fraudulent activity was involved in providing the response. In some examples, location information of the device can indicate that a location of the device is outside a threshold distance from a previously recorded location of the device. This indicates a compromised account or a compromised device, which is indicative of a malicious or fraudulent event. In some examples, device information of the device can indicate that a new device was used to respond to the verification challenge or that the device to which the verification challenge was sent is not the same device that was used to respond to the verification challenge. This indicates a compromised account or a compromised device, which is indicative of a malicious or fraudulent event. In some examples, the information related to the response to the verification challenge can indicate that the user who provided the response is unverified even if the response to the verification challenge is correct because the correct response comes from an account or a device that is compromised.

At operation 414, computing system generates a notification for the first device based on the response to the verification challenge. For example, the server system 102, using the identity verification system 106, generates a notification indicating that the second user successfully completed, failed, timed out, or denied the verification challenge. The notification is provided to the first user via the user device 104a.

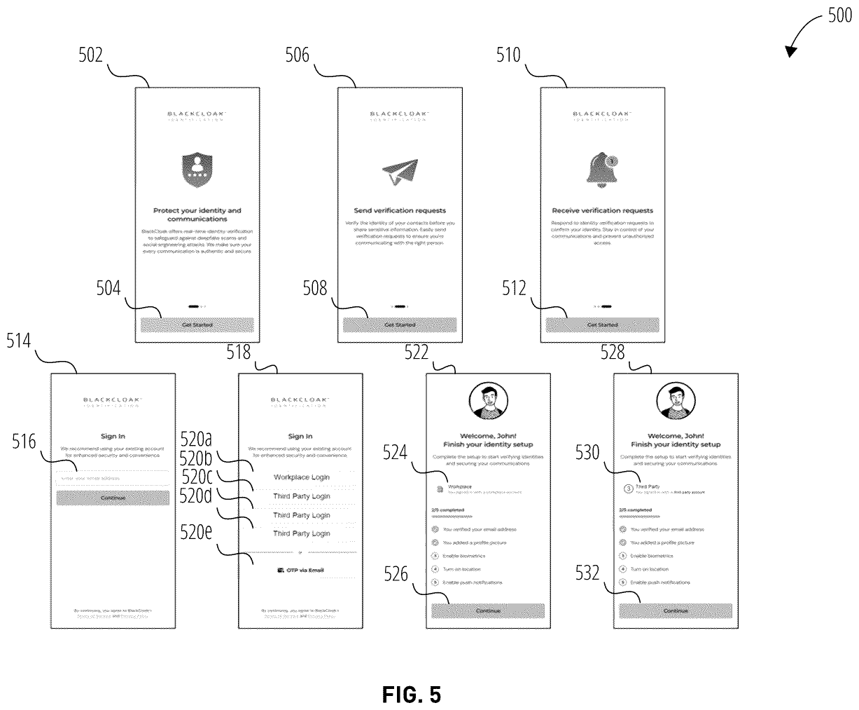

FIG. 5 illustrates example interfaces 500, according to some example embodiments. The example interfaces 500 are presented, for example, as part of an account set up process or a log in process as described with respect to FIG. 1. For example, the example interfaces 500 are presented by the user device 104a or the user device 104b via the identity verification application 110a or the identity verification application 110b. While the example interfaces 500 are depicted in a particular sequence, the sequence may be altered without departing from the scope of the present disclosure.

As illustrated in FIG. 5, a first introduction interface 502 provides information describing functions performed, for example, by the identity verification application 110a or the identity verification application 110b. The information indicates the identity verification application 110a or the identity verification application 110b provides real-time identity verification to safeguard against deepfake scams and social engineering attacks, ensuring every communication is authentic and secure. The first introduction interface 502 includes a selectable element 504 to advance past the first introduction interface 502.

A second introduction interface 506 provides information describing functions performed, for example, by the identity verification application 110a or the identity verification application 110b. The information indicates the identity verification application 110a or the identity verification application 110b facilitates verification of the identity of contacts before sharing sensitive information by sending verification requests to ensure communication is with the correct person. The second introduction interface 506 includes a selectable element 508 to advance past the second introduction interface 506.

A third introduction interface 510 provides information describing functions performed, for example, by the identity verification application 110a or the identity verification application 110b. The information indicates the identity verification application 110a or the identity verification application 110b facilitates responding to identity verification requests to confirm identity, which helps to control communications and prevent unauthorized access. The third introduction interface 510 includes a selectable element 512 to advance past the third introduction interface 510.

A first login interface 514 facilitates login using login credentials. In this example, the first login interface 514 facilitates login using an e-mail address which is entered in an e-mail input 516.

A second login interface 518 facilitates login using login credentials. In this example, the second login interface 518 includes a first selectable element 520a to facilitate login using a workplace login, a second selectable element 520b to facilitate login using a first third-party login, a third selectable element 520c to facilitate login using a second third-party login, and a fourth selectable element 520d to facilitate login using a third third-party login. The workplace login, first third-party login, second third-party login, and third third-party login can be used for login in addition or as alternatives to the e-mail address provided in the first login interface 514. The second login interface 518 includes a fifth selectable element 520e to facilitate login using a one-time passcode sent to the e-mail address provided in the first login interface 514.

A first setup interface 522 facilitates setting up an account. In this example, the first setup interface 522 includes an identifier 524 indicating that a workplace login was used to log in. The first setup interface 522 includes a selectable element 526 to advance past the first setup interface 522.

A second setup interface 528 facilitates setting up an account. In this example, the second setup interface 528 includes an identifier 530 indicating that a third-party login was used to log in. The second setup interface 528 includes a selectable element 532 to advance past the second setup interface 528.

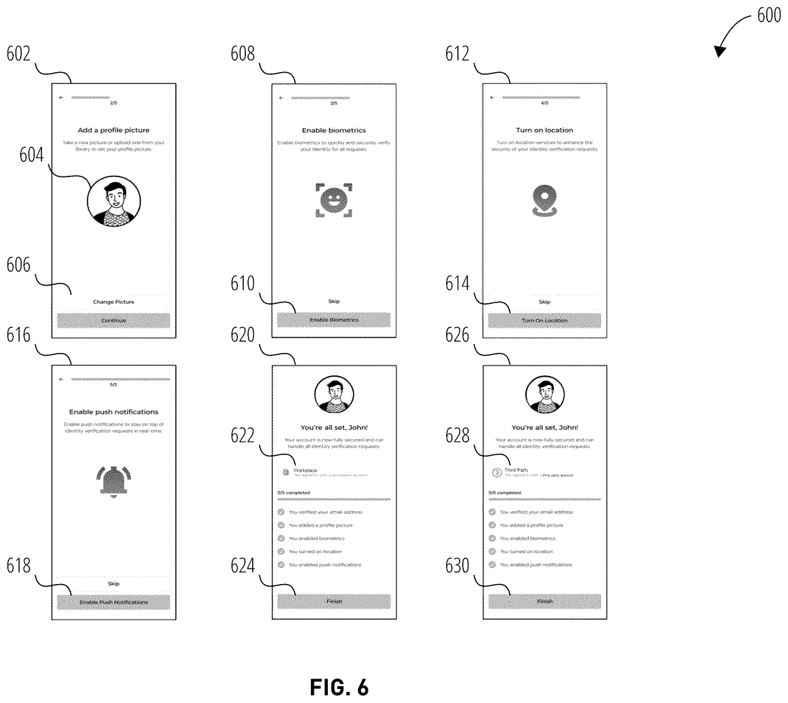

FIG. 6 illustrates example interfaces 600, according to some example embodiments. The example interfaces 600 are presented, for example, as part of an account set up process as described with respect to FIG. 1. For example, the example interfaces 600 are presented by the user device 104a or the user device 104b via the identity verification application 110a or the identity verification application 110b. While the example interfaces 600 are depicted in a particular sequence, the sequence may be altered without departing from the scope of the present disclosure.

As illustrated in FIG. 6, a third setup interface 602 facilitates setting up an account with a profile picture. In this example, the third setup interface 602 includes a profile picture 604 associated with a user of the account. The third setup interface 602 includes a selectable element 606 to change the profile picture 604.

A fourth setup interface 608 facilitates setting up an account to use biometric verification. In this example, the fourth setup interface 608 includes a selectable element 610 to enable biometric scanning functions that are used to respond to a verification challenge using biometric verification.

A fifth setup interface 612 facilitates setting up an account to use location information. In this example, the fifth setup interface 612 includes a selectable element 614 to enable location services that are used to provide location information to verify a request for a verification challenge and to verify a response to a verification challenge.

A sixth setup interface 616 facilitates setting up an account with push notifications. In this example, the sixth setup interface 616 includes a selectable element 618 to enable push notifications that are used to alert a user that a verification challenge has been requested, that a verification challenge has been successfully completed, that a verification challenge has been unsuccessfully completed, that a verification challenge has timed out, or that a verification challenge has been denied.

A seventh setup interface 620 confirms setup for an account is successfully completed. In this example, the seventh setup interface 620 includes an identifier 622 indicating that a workplace login was used to log in. The seventh setup interface 620 includes a selectable element 624 to complete the account setup process.

An eighth setup interface 626 confirms setup for an account is successfully completed. In this example, the eighth setup interface 626 includes an identifier 628 indicating that a workplace login was used to log in. The eighth setup interface 626 includes a selectable element 630 to complete the account setup process.

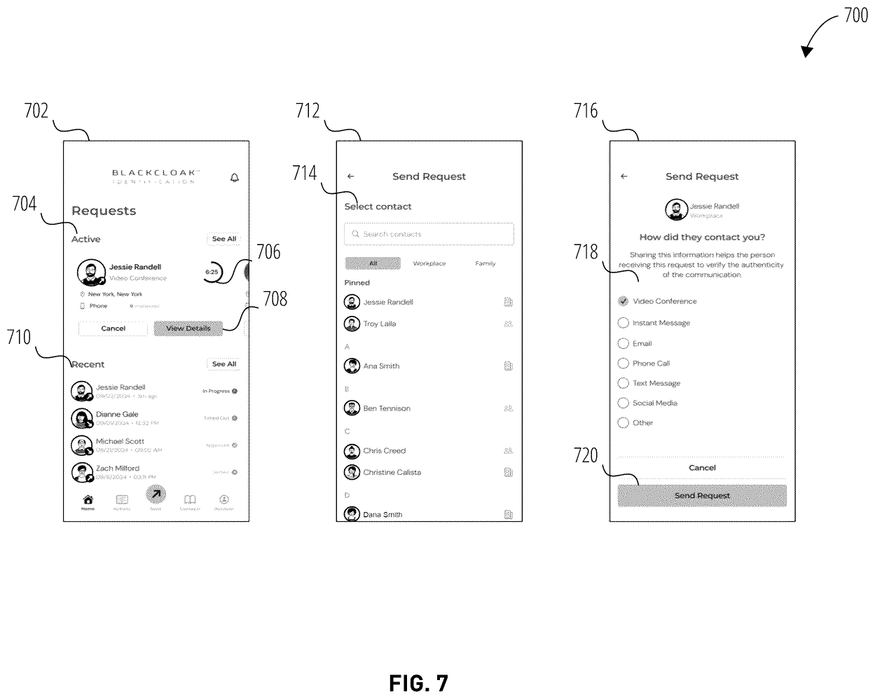

FIG. 7 illustrates example interfaces 700, according to some example embodiments. The example interfaces 700 are presented, for example, as part of a process to request a verification challenge as described with respect to FIG. 1. For example, the example interfaces 700 are presented by the user device 104a or the user device 104b via the identity verification application 110a or the identity verification application 110b. While the example interfaces 700 are depicted in a particular sequence, the sequence may be altered without departing from the scope of the present disclosure.

As illustrated in FIG. 7, a first verification challenge request interface 702 facilitates making a request for a verification challenge. In this example, the first verification challenge request interface 702 includes active request information 704 for verification challenges that have been requested and are awaiting a response. The active request information 704 includes a time remaining 706 and a selectable element 708 to view additional details related to the active request information 704. The first verification challenge request interface 702 includes a verification challenge history 710 of verification challenges that have been requested and verification challenges that have been received.

A second verification challenge request interface 712 facilitates selecting a contact for whom to request for a verification challenge. In this example, the second verification challenge request interface 712 includes an address book 714 of contacts. Selection of a contact from the address book 714 initiates a request for a verification challenge to the selected contact.

A third verification challenge request interface 716 facilitates making a request for a verification challenge. In this example, the third verification challenge request interface 716 includes a communication method list 718 that facilitates selection of a communication method to verify through the verification challenge. The third verification challenge request interface 716 includes a selectable element 720 to send a request for a verification challenge.

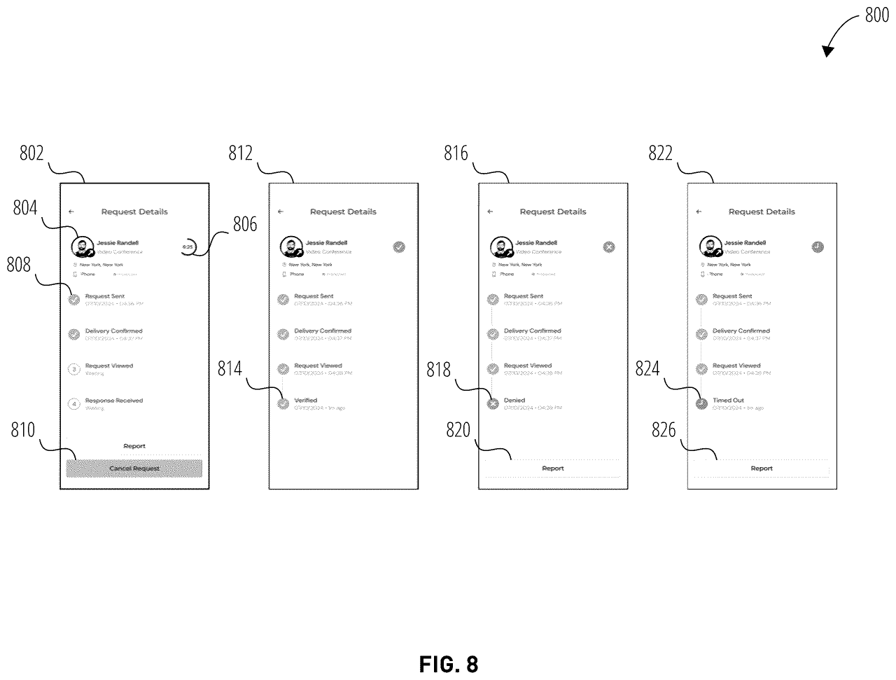

FIG. 8 illustrates example interfaces 800, according to some example embodiments. The example interfaces 800 are presented, for example, as part of a process to request a verification challenge as described with respect to FIG. 1. For example, the example interfaces 800 are presented by the user device 104a or the user device 104b via the identity verification application 110a or the identity verification application 110b. While the example interfaces 800 are depicted in a particular sequence, the sequence may be altered without departing from the scope of the present disclosure.

As illustrated in FIG. 8, a first verification challenge status interface 802 includes active request information 804, which provides information related to a user for whom a verification challenge is requested. The active request information 804 includes a time remaining 806 to indicate how much time remains before the verification challenge times out. The first verification challenge status interface 802 includes a status indicator 808 that describes the status of the verification challenge, including that the request for the verification challenge has been sent, the verification challenge has been received, the verification challenge has been reviewed, and a response to the verification challenge has been received. The first verification challenge status interface 802 includes a selectable element 810 to cancel the verification challenge.

A second verification challenge status interface 812 facilitates notifying a user of a response to a verification challenge. In this example, the second verification challenge status interface 812 includes a response indicator 814 indicating that a verification challenge is successfully completed and the user to whom the verification challenge was sent is verified.

A third verification challenge status interface 816 facilitates notifying a user of a response to a verification challenge. In this example, the third verification challenge status interface 816 includes a response indicator 818 indicating that a verification challenge is denied. The third verification challenge status interface 816 includes a selectable element 820 to send a report related to the verification challenge, such as a report of a potential malicious event.

A fourth verification challenge status interface 822 facilitates notifying a user of a response to a verification challenge. In this example, the fourth verification challenge status interface 822 includes a response indicator 824 indicating that a verification challenge timed out. The fourth verification challenge status interface 822 includes a selectable element 826 to send a report related to the verification challenge, such as a report of a potential malicious event.

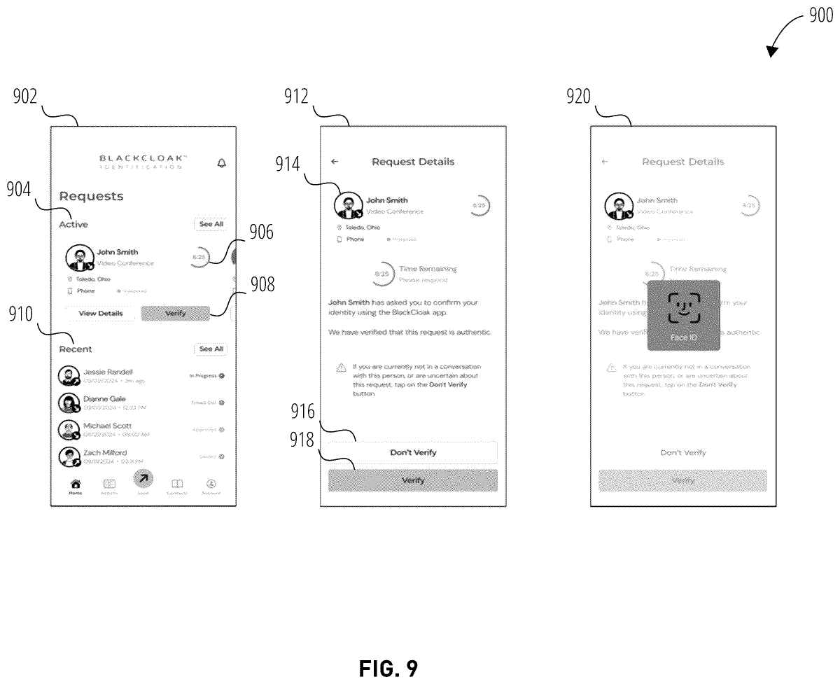

FIG. 9 illustrates example interfaces 900, according to some example embodiments. The example interfaces 900 are presented, for example, as part of a process to respond to a verification challenge as described with respect to FIG. 1. For example, the example interfaces 900 are presented by the user device 104a or the user device 104b via the identity verification application 110a or the identity verification application 110b. While the example interfaces 900 are depicted in a particular sequence, the sequence may be altered without departing from the scope of the present disclosure.

As illustrated in FIG. 9, a first verification challenge response interface 902 facilitates responding to a verification challenge. In this example, the first verification challenge response interface 902 includes active verification challenge information 904 for verification challenges that have been received and are awaiting a response. The active verification challenge information 904 includes a time remaining 906 before the verification challenge times out and a selectable element 908 to respond to the verification challenge. The first verification challenge response interface 902 includes a verification challenge history 910 of verification challenges that have been requested and verification challenges that have been received.

A second verification challenge response interface 912 facilitates responding to a verification challenge. In this example, the second verification challenge response interface 912 includes active verification challenge information 914, which includes information related to a user from whom a verification challenge was requested. The second verification challenge response interface 912 includes a first selectable element 916 to deny (e.g., don't verify) the verification challenge. The second verification challenge response interface 912 includes a second selectable element 918 to respond (e.g., verify) the verification challenge.

A third verification challenge response interface 920 facilitates responding to a verification challenge. In this example, the third verification challenge response interface 920 includes a biometric verification challenge that allows a user to respond to the verification challenge with a biometric scan.

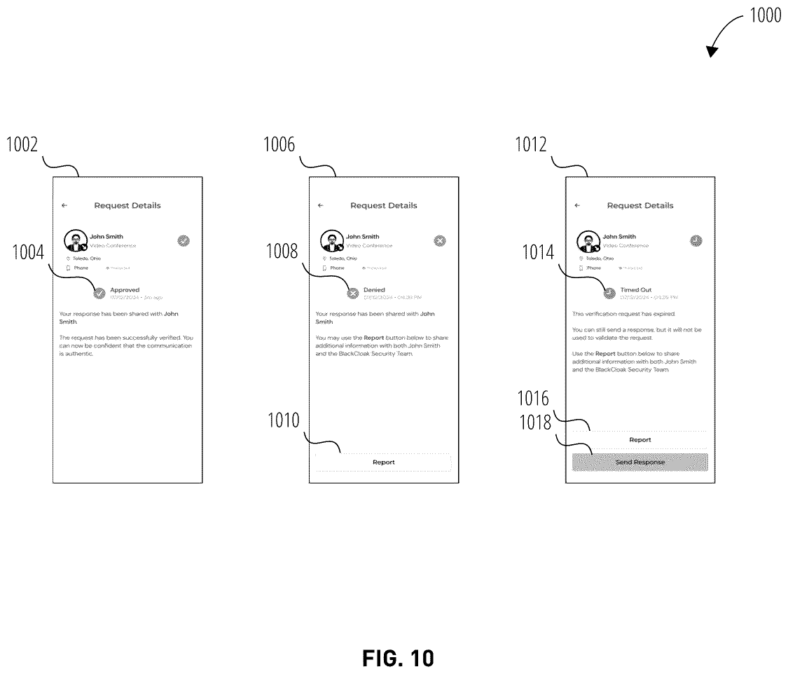

FIG. 10 illustrates example interfaces 1000, according to some example embodiments. The example interfaces 1000 are presented, for example, as part of a process to respond to a verification challenge as described with respect to FIG. 1. For example, the example interfaces 1000 are presented by the user device 104a or the user device 104b via the identity verification application 110a or the identity verification application 110b. While the example interfaces 1000 are depicted in a particular sequence, the sequence may be altered without departing from the scope of the present disclosure.

As illustrated in FIG. 10, a first verification challenge response details interface 1002 includes an indicator 1004 with information indicating that a verification challenge that was received has been successfully completed and that a communication between the user who requested the verification challenge and the user who responded to the verification challenge is verified.

A second verification challenge response details interface 1006 includes an indicator 1008 with information indicating that a verification challenge that was received has been denied. The second verification challenge includes a selectable element 1010 to facilitate reporting a potentially malicious event.

A third verification challenge response details interface 1012 includes an indicator 1014 with information indicating that a verification challenge that was received has timed out. The third verification challenge includes a first selectable element 1016 to facilitate reporting a potentially malicious event. The third verification challenge includes a second selectable element 1018 to send a response to the verification challenge.

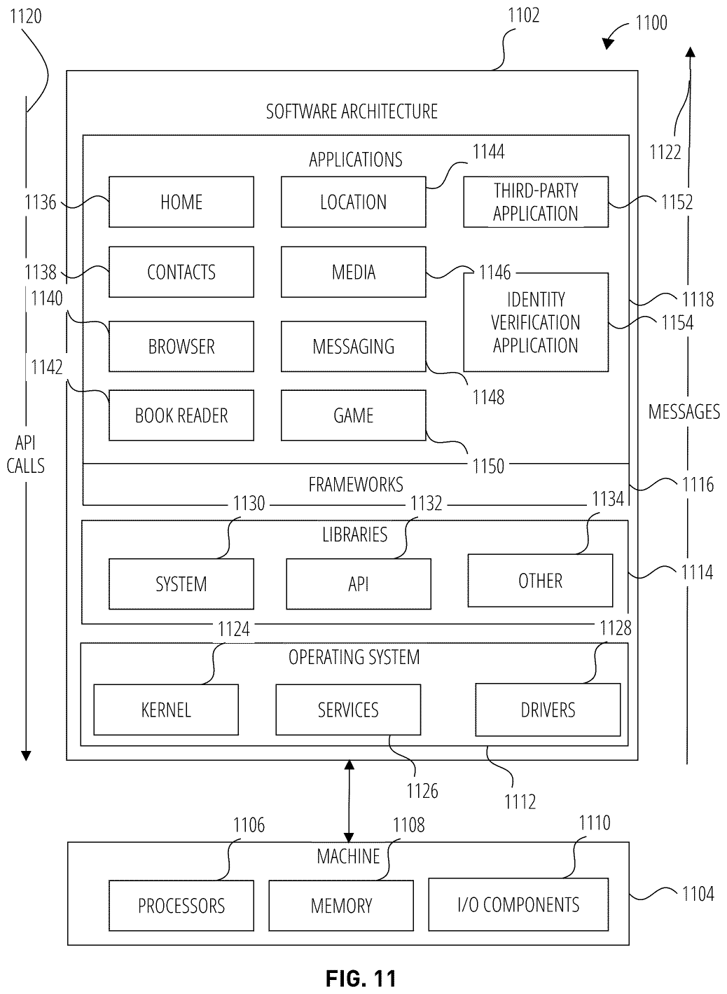

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. The third-party application 1152 may be desktop software running on a desktop operating system, such as Windows, macOS, and Linux. In this example, the third-party application 1152 can invoke the API calls 1120 provided by the operating system 1112 to facilitate functionalities described herein.

Some examples include an identity verification application 1154. For example, the identity verification application 1154 may be a stand-alone application that operates to manage communications with a server system such as server system 102. In some examples, this functionality may be integrated with another application such as a personal security application. Identity verification application 1154 may facilitate, for example, requesting verification challenges and responding to verification challenges. Functionality related to identity verification and verification challenges may be managed by identity verification application 1154 using frameworks 1116, libraries 1114 elements, or operating system 1112 elements operating on a machine 1200.

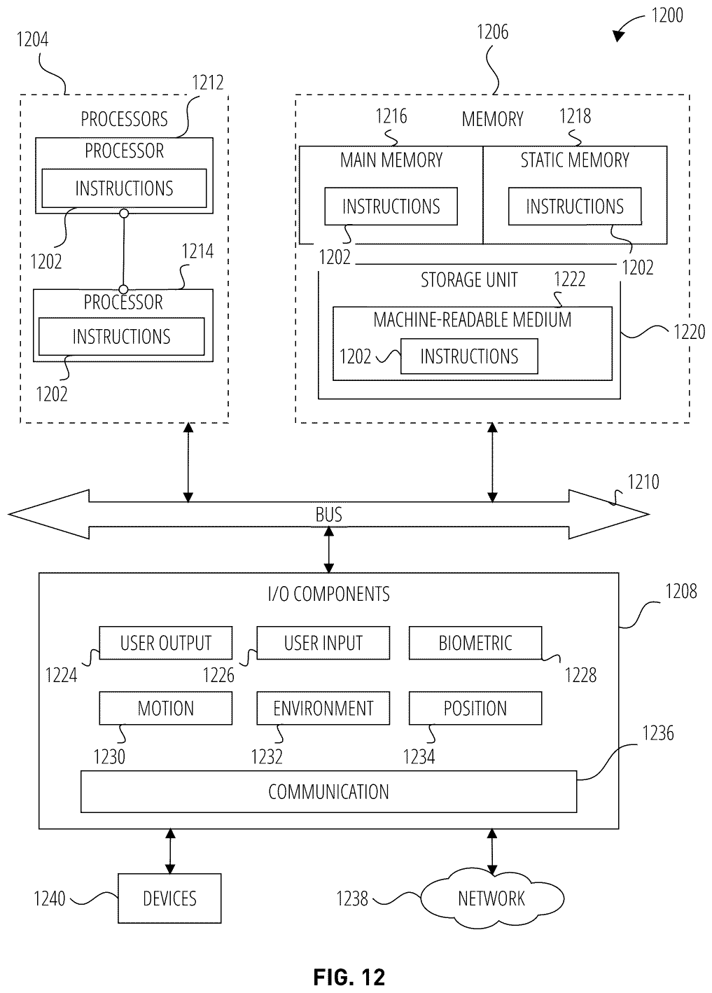

FIG. 12 is a diagrammatic representation of the machine 1200 within which instructions 1202 (e.g., software, a program, an application, an applet, an app, or other executable code) for causing the machine 1200 to perform any one or more of the methodologies discussed herein may be executed. For example, the instructions 1202 may cause the machine 1200 to execute any one or more of the methods described herein. The instructions 1202 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1202, sequentially or otherwise, that specify actions to be taken by the machine 1200. Further, while a single machine 1200 is illustrated, the term “machine” shall also be taken to include a collection of machines that individually or jointly execute the instructions 1202 to perform any one or more of the methodologies discussed herein. The machine 1200, for example, may comprise the user device 104a, user device 104b or any one of multiple server devices forming part of the server system 102. In some examples, the machine 1200 may also comprise both client and server systems, with certain operations of a particular method or algorithm being performed on the server-side and with certain operations of the method or algorithm being performed on the client-side.

The machine 1200 may include processors 1204, memory 1206, and input/output I/O components 1208, which may be configured to communicate with each other via a bus 1210.

The memory 1206 includes a main memory 1216, a static memory 1218, and a storage unit 1220, both accessible to the processors 1204 via the bus 1210. The memory 1206, the static memory 1218, and storage unit 1220 store the instructions 1202 embodying any one or more of the methodologies or functions described herein. The instructions 1202 may also reside, completely or partially, within the main memory 1216, within the static memory 1218, within machine-readable medium 1222 within the storage unit 1220, within at least one of the processors 1204 (e.g., within the processor's cache memory), or any suitable combination thereof, during execution thereof by the machine 1200.

The I/O components 1208 may include a wide variety of components to receive input, provide output, produce output, transmit information, exchange information, capture measurements, and so on. The specific I/O components 1208 that are included in a particular machine will depend on the type of machine. For example, portable machines such as mobile phones may include a touch input device or other such input mechanisms, while a headless server machine will likely not include such a touch input device. It will be appreciated that the I/O components 1208 may include many other components that are not shown in FIG. 12. In various examples, the I/O components 1208 may include user output components 1224 and user input components 1226. The user output components 1224 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1208 may include biometric components 1228, motion components 1230, environmental components 1232, or position components 1234, among a wide array of other components. For example, the biometric components 1228 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

No biometric data collected by the biometric components is stored or made accessible outside the secure environment of the machine 1200. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1230 include acceleration sensor components (e.g., accelerometer), gravitation sensor components, rotation sensor components (e.g., gyroscope).

The environmental components 1232 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user device 104a or the user device 104b may have a camera system comprising, for example, front cameras on a front surface of the user device 104a or the user device 104b and rear cameras on a rear surface of the user device 104a or the user device 104b. The front cameras may, for example, be used to capture still images and video of a user of the user device 104a or the user device 104b (e.g., “selfies”). The rear cameras may, for example, be used to capture still images and videos in a more traditional camera mode, with these images similarly being modified with digital effect data. In addition to front and rear cameras, the user device 104a or the user device 104b may also include a 360° camera for capturing 360° photographs and videos.

Communication may be implemented using a wide variety of technologies. The I/O components 1208 further include communication components 1236 operable to couple the machine 1200 to a network 1238 or devices 1240 via respective coupling or connections. For example, the communication components 1236 may include a network interface component or another suitable device to interface with the network 1238. In further examples, the communication components 1236 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1240 may be another machine or any of a wide variety of peripheral devices (e.g., a peripheral device coupled via a USB).

Moreover, the communication components 1236 may detect identifiers or include components operable to detect identifiers. For example, the communication components 1236 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1236, such as location via Internet Protocol (IP) geolocation, location via Wi-Fi® signal triangulation, location via detecting an NFC beacon signal that may indicate a particular location, and so forth.

The various memories (e.g., main memory 1216, static memory 1218, and memory of the processors 1204) and storage unit 1220 may store one or more sets of instructions and data structures (e.g., software) embodying or used by any one or more of the methodologies or functions described herein. These instructions (e.g., the instructions 1202), when executed by processors 1204, cause various operations to implement the disclosed examples.

The instructions 1202 may be transmitted or received over the network 1238, using a transmission medium, via a network interface device (e.g., a network interface component included in the communication components 1236) and using any one of several well-known transfer protocols (e.g., hypertext transfer protocol (HTTP)). Similarly, the instructions 1202 may be transmitted or received using a transmission medium via a coupling (e.g., a peer-to-peer coupling) to the devices 1240.

Throughout the present disclosure, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these example embodiments without departing from the broader scope of the present disclosure.

The example embodiments illustrated herein are described in sufficient detail to enable those skilled in the art to practice the teachings disclosed. Other example embodiments may be used and derived therefrom, such that structural and logical substitutions and changes may be made without departing from the scope of the present disclosure. The present disclosure, therefore, is not to be taken in a limiting sense, and the scope of various example embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. Accordingly, the present disclosure is to be regarded in an illustrative rather than a restrictive sense.

1. A method comprising:
providing, on a display of a computing device, a first interface comprising a list of verification challenges based on a communication occurring between a first user with a first device separate from the computing device and a second user with a second device separate from the computing device;
receiving, by the computing device, a selection of a verification challenge from the list of verification challenges and an identification of a communication mode of the communication occurring between the first user and the second user; and
performing, by the computing device, the verification challenge to verify an identity of the second user, wherein performing the verification challenge comprises:
transmitting, by the computing device, a verification request for the verification challenge to the second user, the verification request transmitted outside the communication occurring between the first user and the second user while the communication is occurring;
providing, on the display of the computing device, a second interface comprising a first time the verification request was transmitted;
providing, on the second interface, a second time the verification request was received based on a determination the verification request was received by the second user;
providing, on the second interface, a time remaining before the verification request times out;
receiving a response to the verification challenge, the response comprising a confirmation of the communication mode and a result of the verification challenge; and
providing, on the second interface, a notification based on the response to the verification challenge, the notification indicating a successful completion, a failure, a time out, or a denial of the verification challenge.

2. The method of claim 1, further comprising:
providing, by the computing device, information related to the verification request to an identity verification system, the information comprising at least one of a time stamp associated with the verification request, a location associated with the verification request, or device details associated with the verification request.

3. The method of claim 2, wherein a determination a malicious event has occurred is made based on at least one of:
the time stamp associated with the verification request indicating that the verification request was provided within a threshold period of time from a previous request,
based on the location associated with the verification request being outside a threshold distance from a previously recorded location for the computing device; or
the device details associated with the verification request being different from previously recorded device details for the computing device.

4. The method of claim 1, wherein providing the notification is further based on at least one of a time stamp associated with the response, a location associated with the response, or device details associated with the response, the method further comprising:
determining an authentication fatigue attack based on the second user receiving at least a threshold number of verification challenges within a threshold period of time from a plurality of devices; and
preventing subsequent verification challenges to the second user based on the authentication fatigue attack.

5. The method of claim 1, wherein the list of verification challenges is based on a security profile, the security profile indicating which verification challenges are selectable for the second user.

6. The method of claim 1, wherein the verification request is transmitted directly to a third user device associated with the second user, the method further comprising:
determining, by the computing device, the successful completion, the failure, the time out, or the denial of the verification challenge based on a comparison of the response to the verification challenge with information maintained by the computing device.

7. The method of claim 1, further comprising:
providing, by the computing device, a list of contacts, each contact in the list of contacts being associated with a respective status, each respective status indicating whether the respective contact is associated with a compromised account or a compromised device.

8. The method of claim 1, further comprising:
receiving, by the computing device, a message indicating an account or a device receiving the verification challenge is compromised based on a risk score associated with the account or the device, the risk score calculated based on information provided with the response to the verification challenge, the information comprising at least one of a timestamp associated with the response, a location associated with the response, or device details associated with the response, the risk score calculated using a weighted sum or a weighted average of risk values associated with the information provided with the response to the verification challenge.

9. The method of claim 1, wherein the notification indicating the successful completion of the verification challenge includes instructions to continue the communication, the notification indicating the failure of the verification challenge includes instructions to cease the communication, the notification indicating the time out of the verification challenge includes instructions to case the communication, and the notification indicating the denial of the verification challenge includes instructions to cease the communication.

10. The method of claim 1, wherein the first interface and the second interface are provided using a lightweight application that does not facilitate responses to verification challenges.

11. A device comprising:
one or more processors; and
a memory storing instructions that, when executed by the one or more processors, cause the device to perform operations comprising:
providing, on a display of the device, a first interface comprising a list of verification challenges based on a communication occurring between a first user with a first user device separate from the device and a second user with a second user device separate from the device;
receiving a selection of a verification challenge from the list of verification challenges and an identification of a communication mode of the communication occurring between the first user and the second user; and
performing the verification challenge to verify an identity of the second user, wherein performing the verification challenge comprises:
transmitting a verification request for the verification challenge, the verification request transmitted outside the communication occurring between the first user and the second user while the communication is occurring;
providing, on the display of the device, a second interface comprising a first time the verification request was transmitted;
providing, on the second interface, a second time the verification request was received based on a determination the verification request was received by the second user,
providing, on the second interface, a time remaining before the verification request times out;
receiving a response to the verification challenge, the response comprising a confirmation of the communication mode and a result of the verification challenge; and
providing, on the second interface, a notification based on the response to the verification challenge, the notification indicating a successful completion, a failure, a time out, or a denial of the verification challenge.

12. The device of claim 11, the operations further comprising:
providing information related to the verification request to an identity verification system, the information comprising at least one of a time stamp associated with the verification request, a location associated with the verification request, or device details associated with the verification request.

13. The device of claim 12, wherein a determination a malicious event has occurred is made based on at least one of:
the time stamp associated with the verification request indicating that the verification request was provided within a threshold period of time from a previous request,
based on the location associated with the verification request being outside a threshold distance from a previously recorded location for the device; or
the device details associated with the verification request being different from previously recorded device details for the device.

14. The device of claim 11, wherein providing the notification is further based on information related to the response, the information comprising at least one of a time stamp associated with the response, a location associated with the response, or device details associated with the response.

15. The device of claim 11, wherein the list of verification challenges is based on a security profile, the security profile indicating which verification challenges are selectable for the second user.

16. The device of claim 11, wherein the verification request is transmitted directly to a third user device associated with the second user, the operations further comprising:
determining the successful completion, the failure, the time out, or the denial of the verification challenge based on a comparison of the response to the verification challenge with information maintained by the device.

17. The device of claim 11, the operations further comprising:
providing a list of contacts, each contact in the list of contacts being associated with a respective status, each respective status indicating whether the respective contact is associated with a compromised account or a compromised device.

18. The device of claim 11, further comprising:
receiving a message indicating an account or a user device receiving the verification challenge is compromised based on a risk score associated with the account or the device, the risk score calculated based on information provided with the response to the verification challenge, the information comprising at least one of a timestamp associated with the response, a location associated with the response, or device details associated with the response, the risk score calculated using a weighted sum or a weighted average of risk values associated with the information provided with the response to the verification challenge.

19. A non-transitory computer-readable storage medium including instructions that are executable by one or more processors to cause a computing device to perform operations comprising:
providing, on a display of the computing device, a first interface comprising a list of verification challenges based on for a communication occurring between a first user with a first device separate from the computing device and a second user with a second device separate from the computing device;
receiving, by the computing device, a selection of a verification challenge from the list of verification challenges and an identification of a communication mode of the communication occurring between the first user and the second user; and
performing, by the computing device, the verification challenge to verify an identity of the second user, wherein performing the verification challenge comprises:
transmitting, by the computing device, a verification request for the verification challenge to the second user, the verification request transmitted outside the communication occurring between the first user and the second user while the communication is occurring;
providing, on the display of the computing device, a second interface comprising a first time the verification request was transmitted;
providing, on the second interface, a second time the verification request was received based on a determination the verification request was received by the second user, providing, on the second interface, a time remaining before the verification request times out;
receiving a response to the verification challenge, the response comprising a confirmation of the communication mode and a result of the verification challenge; and
providing, on the second interface, a notification based on the response to the verification challenge, the notification indicating a successful completion, a failure, a time out, or a denial of the verification challenge.

20. The non-transitory computer-readable storage medium of claim 19, the operations further comprising:
providing information related to the verification request to an identity verification system, the information comprising at least one of a time stamp associated with the verification request, a location associated with the verification request, or device details associated with the verification request.
